(19) United States
(12) Patent Application Publication
(10) Pub. No.: US 2012/0127769 A1
(43) Pub. Date: May 24, 2012

(54) Soft Switching Power Converters

(75) Inventor: Gregory Allen Kern, Redwood City, CA (US)

(73) Assignee: SUNEDISON, LLC, Beltsville, MD (US)

(21) Appl. No.: 13/296,561

(22) Filed: Nov. 15, 2011

Related U.S. Application Data
(60) Provisional application No. 61/456,991, filed on Nov. 16, 2010.
(60) Provisional application No. 61/462,810, filed on Feb. 8, 2011.

(51) Int. Cl. H02M 7/5387

(52) U.S. Cl. 363/132

(57) ABSTRACT

Soft switching power converters are described. In one example, a grid tie solar power converter includes an input for receiving a direct current (DC) power input, an h-bridge coupled to the input, and an output coupled to the h-bridge. The h-bridge includes a plurality of power switches. The output includes a first output node and a second output node. The converter also includes a first output inductor coupled between the h-bridge and the first output node, a second output inductor coupled between the h-bridge and the second output node, and a soft switching circuit coupled to the first output inductor and the second output inductor. The soft switching circuit is configured to facilitate zero voltage switching of the plurality of switches of the h-bridge.

### CROSS-REFERENCE TO RELATED APPLICATIONS

This application claims priority to U.S. Provisional Application No. 61/456,991 filed Nov. 16, 2010 and U.S. Provisional Application No. 61/462,810 filed Feb. 8, 2011, the entire disclosures of which are hereby incorporated by reference in their entirety.

### FIELD

This disclosure generally relates to power systems and, more specifically, to soft switching power converters.

### BACKGROUND

In some known solar power systems, a plurality of photovoltaic (PV) panels (also known as solar panels) are logically or physically grouped together to form an array of solar panels. The solar panel array converts solar energy into electrical energy. The electrical energy may be used directly, converted for local use, and/or converted and transmitted to an electrical grid or another destination.

Solar panels generally output direct current (DC) electrical power. To properly couple such solar panels to an electrical grid, or otherwise provide alternating current (AC) power, the electrical power received from the solar panels is converted from DC to AC power. At least some known solar power systems use a single stage or a two-stage power converter to convert DC power to AC power. Some such systems are controlled by a control system to maximize the power received from the solar panels and to convert the received DC power into AC power that complies with utility grid requirements.

However, at least some known solar power converters are relatively inefficient and/or unreliable. Moreover, some known solar power converters have relatively high conducted and/or radiated emissions. Accordingly, a better solution is needed.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

One aspect of the present disclosure is a grid tie solar power converter. The converter includes an input for receiving a direct current (DC) power input, an h-bridge coupled to the input, and an output coupled to the h-bridge. The h-bridge includes a plurality of power switches. The output includes a first output node and a second output node. The converter also includes a first output inductor coupled between the h-bridge and the first output node, a second output inductor coupled between the h-bridge and the second output node, and a soft switching circuit coupled to the first output inductor and the second output inductor. The soft switching circuit configured to facilitate zero voltage switching of the plurality of switches of the h-bridge.

Another aspect of the present disclosure is a grid tie solar power converter. The converter includes an input for receiving a direct current (DC) power input, an h-bridge coupled to the input, an output coupled to the h-bridge, and a soft switching circuit coupled across the output. The h-bridge includes a plurality of power switches. The output includes a first output node and a second output node. The soft switching circuit includes a first branch having a first end coupled to the first output node and a second branch having a first end coupled to the second output node. A second end of the first branch is coupled to a second end of the second branch. Each of the first and second branches includes a switch in series with a diode.

Yet another aspect of the present disclosure is a power converter. The power converter includes an input for receiving a direct current (DC) power input, a DC high rail coupled to the input, a DC low rail coupled to the input, a first power branch including a first power switch and a second power switch coupled between the DC high rail and the DC low rail, a second power branch including a first power switch and a second power switch coupled between the DC high rail and the DC low rail, a soft switching circuit coupled to the first power branch and the second power branch, and an output coupled to the soft switching circuit, the first power branch, and the second power branch. The soft switching circuit is configured to facilitate soft switching of the first and second power switches of the first and second power branches.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic block diagram of an exemplary power conversion system.

FIG. 2 is a schematic diagram of an exemplary converter for use in the system shown in FIG. 1.

FIG. 3 illustrates the control timing for the converter shown in FIG. 2.

FIG. 4 illustrates waveform signals captured from a prototype converter based on the converter shown in FIG. 2.

FIG. 5 is an enlarged view of the waveform signals shown in FIG. 4.

Like reference symbols in the various drawings indicate like elements.

### DETAILED DESCRIPTION

The embodiments described herein generally relate to power systems. More specifically embodiments described herein relate to soft switching power converters. Moreover, some embodiments described herein relate to soft switching power converters for use with a photovoltaic power source.

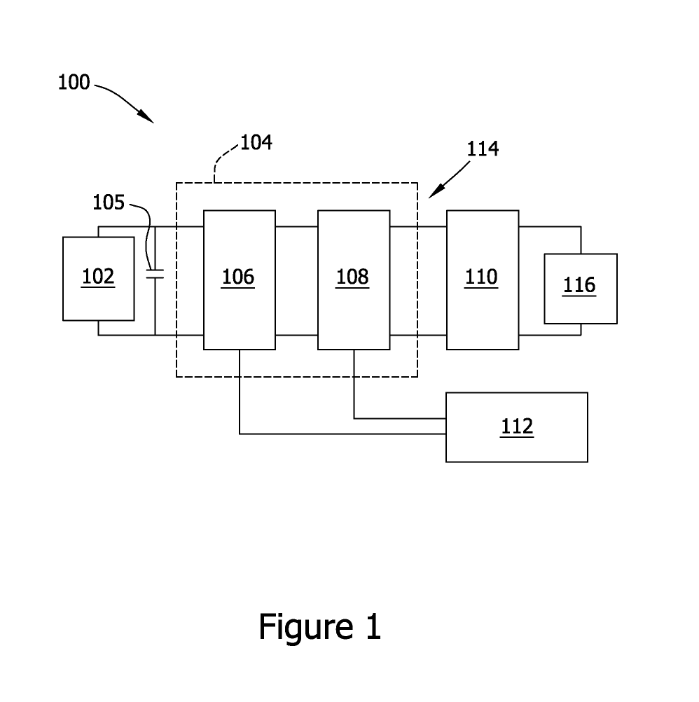

FIG. 1 is a schematic block diagram of an exemplary power conversion system 100. A power source 102 is coupled to power conversion system 100 to supply electrical current to system 100. In an exemplary embodiment, power source 102 is a photovoltaic, or “solar” array that includes at least one photovoltaic panel. Alternatively or additionally, power source 102 includes at least one fuel cell, a direct current (DC) generator, and/or any other electric power source that enables power conversion system 100 to function as described herein.

In an exemplary embodiment, power conversion system 100 includes a power converter 104 to convert DC power received from power source 102, via an input capacitor 105, to an alternating current (AC) output. In other embodiments, power converter 104 may output DC power. The exemplary power converter 104 is a two stage power converter including a first stage 106 and a second stage 108. First stage 106 is a DC to DC power converter that receives a DC power input from power source 102 and outputs DC power to second stage 108. Second stage 108 is a DC to AC power converter (sometimes referred to as an inverter) that converts DC power received from first stage 106 to an AC power output. In other embodiments, power converter 104 may include more or less stages. More particularly, in some embodiments power converter 104 includes only second stage 108.

Power conversion system 100 also includes a filter 110, and a control system 112 that controls the operation of first stage 106 and second stage 108. An output 114 of power converter 104 is coupled to filter 110. In an exemplary embodiment, filter 110 is coupled to an electrical distribution network 116, such as a power grid of a utility company. Accordingly, power converter 104 may be referred to as a grid tied inverter. In other embodiments, power converter 104 may be coupled to any other suitable load.

During operation, power source 102 generates a substantially direct current (DC), and a DC voltage is generated across input capacitor 105. The DC voltage and current are supplied to power converter 104. In an exemplary embodiment, control system 112 controls first stage 106 to convert the DC voltage and current to a substantially rectified DC voltage and current. The DC voltage and current output by first stage 106 may have different characteristics than the DC voltage and current received by first stage 106. For example, the magnitude of the voltage and/or current may be different. Moreover, in the exemplary embodiment, first stage 106 is an isolated converter, which operates, among other things, to isolate power source 102 from the remainder of power conversion system 100 and electrical distribution network 116. The DC voltage and current output by first stage 106 are input to second stage 108, and control system 112 controls second stage 108 to produce AC voltage and current, and to adjust a frequency, a phase, an amplitude, and/or any other characteristic of the AC voltage and current to match the electrical distribution network 116 characteristics. The adjusted AC voltage and current are transmitted to filter 110 for removing one or more undesired characteristics from the AC voltage and current, such as undesired frequency components and/or undesired voltage and/or current ripples. The filtered AC voltage and current are then supplied to electrical distribution network 116.

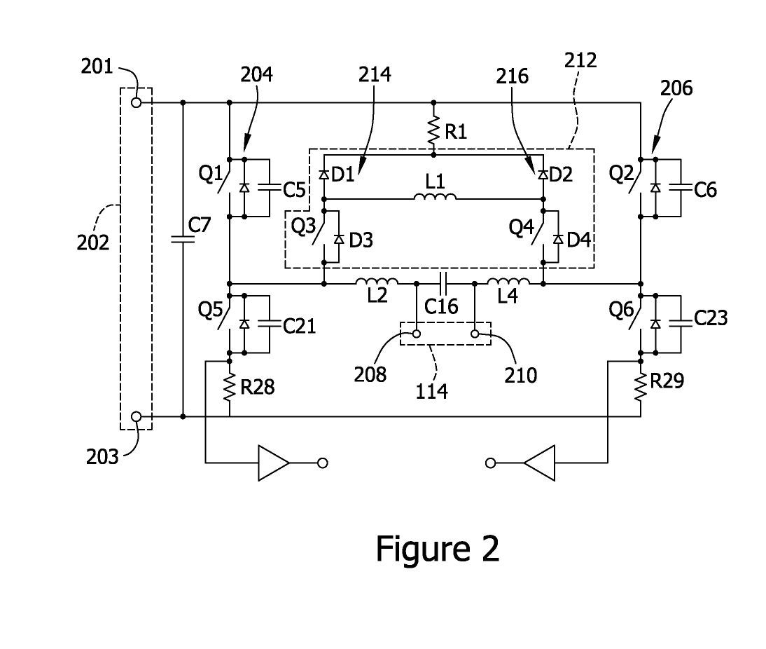

FIG. 2 is a schematic diagram of an exemplary converter 200 for use as second stage 108. Converter 200 is a soft-switching h-bridge converter. Converter 200 is operable to output DC power or AC power. In the exemplary embodiment, converter 200 is operated by control system 112 to output AC power to electrical distribution network 116. Generally, the peak output voltage of converter 200 must be less than the input voltage to converter 200. In one example embodiment, converter 200 is a 200 Watt, 120 Volt, 60 Hz grid tie converter receiving an input of 200 to 400 Vdc.

Converter 200 includes an input 202 for receiving DC power. Input 202 includes a DC high node 201 and a DC low node 203. An input capacitor C7 is coupled to input 202. Input capacitor C7 filters the input to converter 200 to limit switching action of the converter 200 from pulling switching currents from the power source 102 and/or first stage 106. Capacitor C7 may be one or more capacitors. In one exemplary embodiment, capacitor C7 comprises five metalized polypropylene film capacitors each rated at 5.6 uF 500 Vdc, for a total of 28.0 uF. In another exemplary embodiment, Capacitor C& comprises six metalized polypropylene film capacitors each rated at 4.7 uF 450 Vdc, for a total of 28.2 uF.

An h-bridge is coupled, via capacitor C7 to input 202. The h-bridge includes switches Q1, Q2, Q5, and Q6 and capacitors C5, C6, C21 and C23. These are the main power switches in the converter 200. Switches Q1 and Q5 form a first power branch 204 of the h-bridge, and switches Q2 and Q6 form a second power branch 206 of the h-bridge. In the exemplary embodiment, switches Q1, Q2, Q5, and Q6 are metal oxide semiconductor field effect transistors (MOSFETs). Switches Q1, Q2, Q5, and Q6 are controlled so as not to rely on conduction of the body diodes in these switches. Diodes are useful, however, to clamp and protect switches Q1, Q2, Q5, and Q6 by clamping overvoltages to the DC input voltage. Under normal operation overvoltage spikes generally do not occur. If, however, converter 200 is forced by controller 112 to immediately shutdown while operating, switches Q1, Q2, Q5, and Q6 are turned off and diodes in parallel with switches Q1, Q2, Q5, and Q6 clamp the overvoltage spike that would otherwise occur. In the exemplary embodiment, switches Q1, Q2, Q5, and Q6, which are MOSFETS, have a built in body diode so an external, or discrete, diode is not needed. In other embodiments, a separate, discrete diode may, additionally or alternatively, be coupled in parallel with each switch Q1, Q2, Q5, and Q6 along with a steering diode in series with each switch Q1, Q2, Q5, and Q6.

The h-bridge is generally operated as well understood by one of ordinary skill in the art. Opposing pairs of switches are alternately switched on and off to produce an AC output. More specifically, switches Q1 and Q6 are switched on and off together, while switches Q2 and Q5 are switched on and off together. When switches Q1 and Q6 are on, switches Q2 and Q5 are off, and vice versa. In the exemplary embodiment, switches Q1, Q2, Q5, and Q6 are switched on and off during zero voltage conditions, i.e. zero voltage switching (ZVS), thereby substantially minimizing switching losses in switches Q1, Q2, Q5, and Q6.

The h-bridge is coupled to output 114. In the exemplary embodiment, output 114 includes a first output node 208 and a second output node 210. A first output inductor L2 is coupled between the h-bridge and first output node 208. More specifically, first output inductor L2 is coupled between the first power branch 204 and first output node 208. A second output inductor L4 is coupled between the h-bridge and second output node 210. More specifically, second output inductor L4 is coupled between the second power branch 206 and second output node 210. First and second output inductors L2 and L4 are the main output filter inductors for converter 200. Use of two separate inductors may reduce common mode electromagnetic emissions from the converter 200. In other embodiments, output inductors L2 and L4 may be replaced with a single inductor. In one exemplary embodiment each output inductor L2 and L4 is rated at 1.3 mH and is made by winding 148 turns of number 20 AWG magnet wire on a magnetic core.

An output capacitor C16 is coupled across output 114. In the exemplary embodiment, output capacitor C16 comprises two film capacitors connected in parallel. In one example embodiment, the two film capacitors are each 0.68 uF capacitors rated for across the line application (also known as X caps). In other embodiments, output capacitor C16 comprises a single capacitor. In one example embodiment, output capacitor C16 is a 0.47 uF capacitor rated for 310 Vac.

A soft switching circuit 212 is coupled to first output inductor L2 and second output inductor L4. Soft switching circuit 212 is configured to facilitate zero voltage switching of switches Q1, Q2, Q5, and Q6 of the h-bridge. Soft switching circuit 212 includes a first branch 214 having a first end coupled to first output inductor L2 and a second branch 216 having a first end coupled to second output inductor L4. The opposite, or second, end of first and second branches 214 and 216 are coupled together.

First and second branches 214 and 216 are substantially identical. First branch 214 includes a switch Q3 in parallel with a diode D3. Switch Q3 and diode D3 are coupled in series with a diode D1. Similarly, second branch 216 includes a switch Q4 in parallel with a diode D4. Switch Q4 and diode D4 are coupled in series with a diode D2. Switches Q3 and Q4 are auxiliary soft switching control switches. In the exemplary embodiment, switches Q3 and Q4 are insulated gate bi-polar transistors (IGBTs).

During operation of converter 200, switches Q3 and Q4 are turned on in a zero current but non-zero voltage condition. IGBTs generally have lower output capacitance than some other switches, thereby reducing the output capacitance that gets shorted, which leads to power dissipation, each time switches Q3 and Q4 are turned on. Accordingly, using IGBTs for switches Q3 and Q4 may improve efficiency of converter 200. Diodes D3 and D4 are separate discrete diodes. In other embodiments, diodes D3 and D4 may be co-packaged with switches Q3 and Q4. In an exemplary embodiment, diodes D3 and D4, are 2 A, 600V rated SiC diodes. In other embodiments, other diodes, including non SiC diodes may be used.

A resonant inductor L1 is coupled between first branch 214 and second branch 216. Inductor L1 controls the soft switching waveform transitions of converter 200. In one exemplary embodiment, inductor L1 is a 48 uH inductor comprising 22 turns of number 18 AWG magnet wire wound on a magnetic core.

Diodes D1 and D2 form a snubber circuit that facilitates clamping overvoltages that may occur on switches Q3 and Q4 if converter 200 were shut down at certain times in the switching cycle when energy is stored on inductor L1. Also, during normal operation of converter 200, overvoltages may also occur (e.g., if the control signals from control system 112 are not precisely timed). Inclusion of diodes D1 and D2 facilitates protecting switches Q3 and Q4 from such overvoltages.

In the exemplary embodiment, a resistor R1 is coupled between diodes D1 and D2 and DC high node 201. Resistor R1 operates, in conjunction with diodes D1 and D2, to clamp overvoltages that may occur on switches Q3 and Q4. Moreover, Resistor R1 permits some of the stored energy in resonant inductor L1 to be returned to input 202 and facilitates restoring volt seconds balance to resonant inductor L1 before the next soft switching pulse. In one example embodiment, resistor R1 is a 39 ohm 3 watt non-inductive power resistor. In another embodiment, resistor R1 is a 110 ohm resistor. In still other embodiments, resistor R1 is omitted from converter 200 and replaced with a short circuit.

Converter 200 includes four pulse capacitors C5, C6, C21, and C23. Capacitors C5, C6, C21, and C23 are coupled across switches Q1, Q2, Q5, and Q6, respectively. Capacitors C5, C6, C21, and C23 add to the inherent output capacitance of switches Q1, Q2, Q5, and Q6. The total output capacitance of switches resonates with the inductor L1 forming a controlled voltage transition during a dead time between switching of the switches Q1, Q2, Q5, and Q6. The capacitance added by capacitors C5, C6, C21, and C23 slows down the rate of change of the voltages across switches Q1, Q2, Q5, and Q6 and thereby reduces the impact of small errors in control signal timing. In other embodiments, capacitors C5, C6, C21, and C23 are eliminated and the output capacitance of switches Q1, Q2, Q5, and Q6, without extra added capacitance, controls the soft switching characteristics of converter 200. In one example embodiment, capacitors C5, C6, C21, and C23 are 1000 pF, 2 kV rated pulse capacitors. In another example embodiment, capacitors C5, C6, C21, and C23 are 470 pF, 1 kV rated pulse capacitors.

Resistors R28 and R29 are current sense resistors. More specifically, resistors R28 and R29 are two separate resistive shunts used for AC current sensing. In the exemplary embodiment, resistors R28 and R29 are 0.025 ohms, 1 watt, non-inductive resistors. Signals from resistors R28 and R29 are amplified by an amplifier circuit (not separately shown) and used by control system 112 as feedback for controlling the output current of converter 200. The amplifier circuits provide gain and offset to the signals from resistors R28 and R29. Each signal path is calibrated separately and common mode gain and differential mode gain applied. The amplified signals are then sensed by control system 112 and sampled at specific times in the switching timing waveform, so that output AC and DC current can be measured and controlled. By sensing at appropriate times in the waveform, each signal can be zeroed automatically and continuously so that drift does not have a negative impact on performance.

In the exemplary embodiment, when switches Q1 and Q6 are on, the output current, of converter 200, flows through R29. If the output current is positive, then a positive voltage is developed across resistor R29 and this signal, after amplification, is used by control system 112 as feedback for control of positive output current. When switches Q2 and Q5 are on, the output current flows through resistor R28. If the output current is negative, then a positive voltage is developed across resistor R28 and this signal, after amplification, is used by control system 112 as feedback for control of negative output current. In other embodiments, positive and/or negative signals from both sense resistors are utilized as feedback by control system 112. The inclusion of current sense amplifiers and current sense resistors R28 and R29 may obviate the need for any current transformer in converter 200. Further, magnetic or hall-effect current-sensing devices, which often have problems of drift or dc output current control, may be omitted.

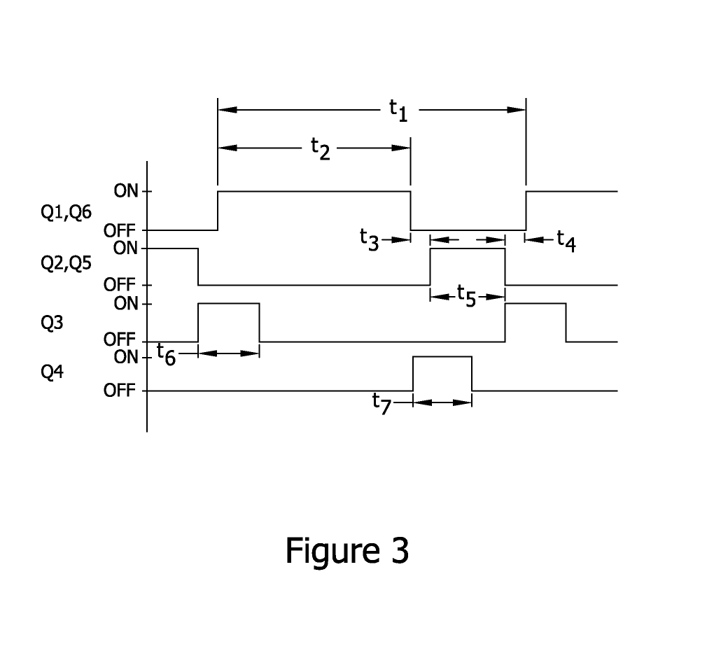

FIG. 3 graphically illustrates the control timing for converter 200 at a duty cycle of about 0.68. This figure is not to scale, the time around the switch transitions has been expanded for clarity. Time t1 is the switching period of converter 200. In the exemplary embodiment, converter 200 operates at a switching frequency of about fifty kHz. Accordingly, time t1 is about twenty microseconds. Time t2 is the time that power switches Q1 and Q6 are switched on. Switches Q1 and Q6 are always controlled so that they are both on and off at the same time. In other embodiments, Q1 and Q6 are not always switched on and off at the same time. Time t5 is the time that power switches Q2 and Q5 are ON. Switches Q2 and Q5 are also always ON and OFF at the same time. In other embodiments, Q2 and Q5 are not always switched on and off at the same time.

Time t3 is a dead time, i.e. none of switches Q1, Q2, Q5, or Q6 is conducting, between the turn off of switches Q1 and Q6 and the turn on of switches Q2 and Q5. Time t4 is a dead time between the turn off of switches Q2 and Q5 and the turn on of switches Q1 and Q6. In the exemplary embodiment, times t3 and t4 are equal and approximately 1.1 microseconds. In other embodiments, times t3 and t4 may have other lengths and/or may not be the equal. In the exemplary embodiment, switching timing is controlled by control system 112 based on fixed timing control. The timing of switching does not vary as a function of output current amplitude. In other embodiments, control system 112 adjusts switch timing as a function of output current amplitude. The transition time of switches Q1, Q2, Q5, and Q6 varies depending upon the amplitude and direction of output current. Accordingly, varying switch timing as a function of output current may permit more efficient and/or accurate switching. Times t3 and t4 need to be long enough to let the resonant switching action provide a smooth transition on the output voltages of power switches Q1, Q2, Q5, and Q6. In some embodiments, switch Q4 is turned on when the output current of converter 200 is negative, rather than being based on a fixed timing.

Time t6 is the time that soft switching circuit 212 switch Q3 is on. Switch Q3 turns on at substantially the same time that switches Q2 and Q5 turn off. In some embodiments, a slight time shift, positive or negative, between turn off of switches Q2 and Q5 and turn on of switch Q3 may be added. Time t7 is the time that soft switching circuit 212 switch Q4 is on. Switch Q4 turns on at substantially the same time that switches Q1 and Q6 turn off. In the exemplary embodiment, times t6 and t7 are substantially equal and typically is 1.6 microseconds. In other embodiments, times t6 and t7 may have other lengths and/or may not be the equal. In some embodiments, switch Q3 is turned on when the output current of converter 200 is positive, rather than being based on a fixed timing.

The duty cycle of converter 200 is a ratio that can vary between 0.0 and 1.0. The duty cycle of converter 200 is calculated as the sum of times t2 and one half times t3 plus t4 divided by time t1. Times t3 and t4 are included in the computation because during the dead times t3 and t4, the voltages at the outputs of the power switches Q1, Q2, Q5, and Q6 are undergoing a smooth transition and the effective duty cycle needs to take this into account. When the duty cycle of converter 200 is set to 0.50, the average output voltage of the inverter is zero volts.

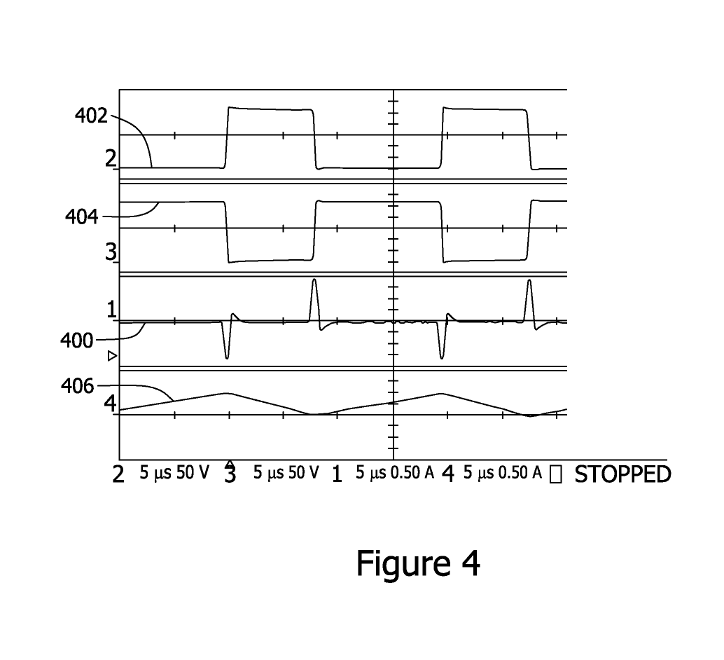

FIG. 4 shows signals captured from a prototype converter based on converter 200. Trace 400 is the current through resonant inductor L1. Trace 402 is the drain to source voltage of switch Q6. Trace 404 is the drain to source voltage of switch Q5. Trace 406 is the output inductor current through inductors L2 and L4. The horizontal scale is time, 5 microseconds per division. The vertical scale is indicated on the bottom of the display and represent one vertical tick division. The zero amplitude for each graph is indicated on the left by a horizontal tick mark. The arrows indicate the scope trigger setup.

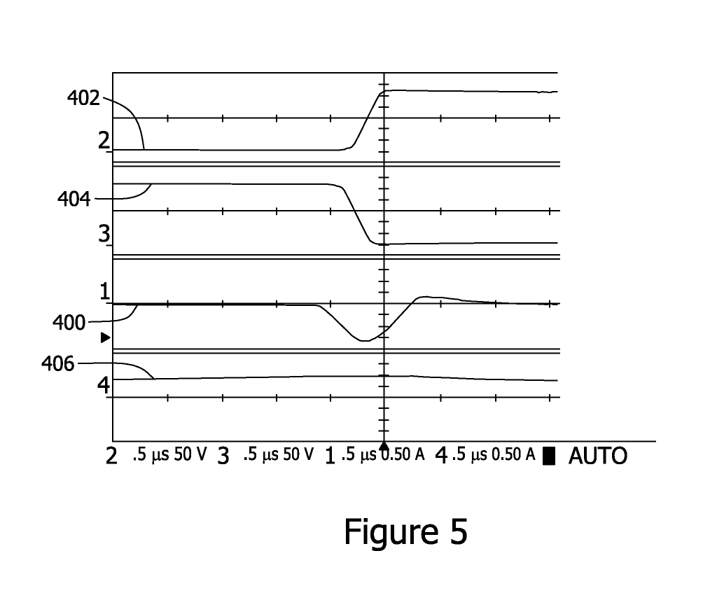

FIG. 5 is an enlarged view of the signals shown in FIG. 4 showing smooth transitions in all of the waveforms.

Power conversion systems including soft switching converters as described herein may achieve superior results to known methods and systems. Soft-switching power converters according to the present disclosure have a limited rate of change of voltage and current, expressed as dv/dt and di/dt respectively, and thus have reduced conducted and radiated emissions as compared to hard switched converters. Moreover, the exemplary soft-switching converters result in higher conversion efficiency than other known converters. The waveforms of the exemplary converters are less dependent upon parasitic characteristics of the components and are better controlled, thus leading to a more reliable converter with an increased lifetime. Unlike some known converters, the exemplary converters described herein also provide soft switching all the way from zero power to full rated power. This approach meets that requirement. Thus, the exemplary soft switching converters allow high conversion efficiency with lower radiated and conducted emissions. These converters allow for better controlled waveforms thus reducing the probability of component failure due to uncontrolled waveform characteristics, such as high dv/dt or di/dt. Moreover, with well controlled soft switching, the design of output inductors (e.g., L2 and L4) is less critical at high frequency than in a hard switched inverter. Accordingly, inductor windings can overlap more and more interwinding capacitance is allowed, reducing the cost of this component compared to its hard switching counterpart.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A solar power converter comprising:
an input for receiving a direct current (DC) power input;
an h-bridge coupled to the input, the h-bridge comprising a plurality of power switches;
an output coupled to the h-bridge, the output comprising a first output node and a second output node;
a first output inductor coupled between the h-bridge and the first output node;
a second output inductor coupled between the h-bridge and the second output node; and
a soft switching circuit coupled to the first output inductor and the second output inductor, the soft switching circuit configured to facilitate zero voltage switching of the plurality of switches of the h-bridge.

2. The power converter according to claim 1, wherein the soft switching circuit comprises a first branch having a first end coupled to the first output inductor and a second branch having a first end coupled to the second output inductor, and wherein a second end of the first branch is coupled to a second end of the second branch.

3. The power converter according to claim 2, wherein each branch comprises a switch in series with a diode.

4. The power converter according to claim 3, wherein the soft switching circuit further comprises a resonant inductor coupled between the first branch and the second branch.

5. The power converter according to claim 4, wherein the resonant inductor is coupled to the first branch and the second branch between each branch's series connected switch and diode.

6. The power converter according to claim 1, further comprising a resistor coupled between the soft switching circuit and the input.

7. The power converter according to claim 6, wherein the resistor is coupled to a high voltage node of the input.

8. The power converter according to claim 1, further comprising an output filter coupled to the output.

9. The power converter according to claim 1, wherein the first and second output inductors comprise a single inductor

10. The power converter according to claim 1, wherein the power converter output is coupled to an alternating current (AC) grid.

11. The power converter of claim 10, wherein the power converter is operable at any power factor.

12. The power converter of claim 11, wherein the power converter is operable to source or sink reactive power into the AC grid.

13. The power converter according to claim 1, wherein the power converter output is a stand alone voltage source for powering one or more loads.

14. A solar power converter comprising:
an input for receiving a direct current (DC) power input;
an h-bridge coupled to the input, the h-bridge including a plurality of power switches;
an output coupled to the h-bridge, the output having a first output node and a second output node;
a soft switching circuit coupled across the output, the soft switching circuit including a first branch having a first end coupled to the first output node and a second branch having a first end coupled to the second output node, a second end of the first branch is coupled to a second end of the second branch, and each of the first and second branches comprises a switch in series with a diode.

15. The power converter according to claim 14, wherein the soft switching circuit further comprises a resonant inductor coupled between the first branch and the second branch.

16. The power converter according to claim 15, wherein the resonant inductor is coupled to the first branch and the second branch between each branch's series connected switch and diode.

17. The power converter according to claim 14, further comprising a resistor coupled between the soft switching circuit and the input.

18. The power converter according to claim 17, wherein the resistor is coupled to a high voltage node of the input.

19. The power converter according to claim 14, further comprising an output filter coupled to the output.

20. The power converter according to claim 14 further comprising a first output inductor coupled between the h-bridge and the first output node, and a second output inductor coupled between the h-bridge and the second output node, wherein the first branch is coupled to the first output node via the first output inductor and the second branch is coupled to the second output node via the second output inductor.

21. The power converter according to claim 14, wherein the soft switching circuit is configured to facilitate zero voltage switching of the plurality of switches of the h-bridge.

22. A power converter comprising:
an input for receiving a direct current (DC) power input;
a DC high rail coupled to the input;
a DC low rail coupled to the input;
a first power branch comprising a first power switch and a second power switch coupled between the DC high rail and the DC low rail;
a second power branch comprising a first power switch and a second power switch coupled between the DC high rail and the DC low rail;
a soft switching circuit coupled to the first power branch and the second power branch, the soft switching circuit configured to facilitate soft switching of the first and second power switches of the first and second power branches; and
an output coupled to the soft switching circuit, the first power branch, and the second power branch.

23. The power converter according to claim 22, further comprising a first inductor coupled between the output and the first power branch and the soft switching circuit, and a second inductor coupled between the output and the second power branch and the soft switching circuit.

24. The power converter according to claim 22, wherein the soft switching circuit is coupled to the first branch and the second branch between each branch's first and second switches.

25. The power converter according to claim 22, wherein the soft switching circuit comprises a first branch having a first end coupled to a first node of the output and a second branch having a first end coupled to a second node of the output, a second end of the first branch is coupled to a second end of the second branch, and each of the first and second branches comprises a switch in series with a diode.

26. The power converter according to claim 22, further comprising a control system, the first power branch comprising a resistive shunt coupled to the control system and the second power branch comprising a resistive shunt coupled to the control system, the control system configured to sample signals from the first and second power branch's resistive shunts and to control the power converter based, at least in part, on the sampled signals.

27. A power converter comprising:
an input for receiving a direct current (DC) power input;
a DC high rail coupled to the input;
a DC low rail coupled to the input;
a first power branch comprising a first power switch, a second power switch, and a resistive shunt coupled in series between the DC high rail and the DC low rail;
a second power branch comprising a first power switch, a second power switch, and a resistive shunt coupled in series between the DC high rail and the DC low rail; and
a control system coupled to the first power branch resistive shunt and the second power branch resistive shunt, the control system configured to control operation of the power converter based at least in part on signals received from the resistive shunts.

28. The power converter according to claim 27, wherein the control system is configured to separately calibrate signals received from the first branch's resistive shunt and the second branch's resistive shunt.

29. The power converter according to claim 27, wherein the power converter does not include a magnetic or hall effect sensor.

30. The power converter according to claim 27, wherein the controller is configured to periodically sample the signals received from the first and second branch's resistive shunts.
